(19) United States
(12) Patent Application Publication
(10) Pub. No.: US 2009/0190260 A1
(43) Pub. Date: Jul. 30, 2009

(54) HEAD SUSPENSION AND HEAD SUSPENSION ASSEMBLY AND STORAGE APPARATUS

(75) Inventor: Shinichi Kobatake, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/235,150

(22) Filed: Sep. 22, 2008

(30) Foreign Application Priority Data
Jan. 30, 2008 (JP) 2008-019829

(51) Int. Cl. G11B 5/48

(52) U.S. Cl. 360/244.2; G9B/5.147

(57) ABSTRACT

A head slider is mounted at the mounting area on a plate-shaped gimbal in a head suspension. A swelling is formed on the load beam. A viscoelastic body is interposed between the load beam and the gimbal. The back surface of the gimbal is received on the swelling. The head slider on the gimbal is allowed to change its attitude on the swelling. When the gimbal is received on the viscoelastic body, the viscoelastic body serves to suppress the vibration of the gimbal, namely the head slider.

### BACKGROUND OF THE INVENTION

1. Field of the Invention

The present invention relates to a head suspension incorporated in a hard disk drive, HDD, for example.

2. Description of the Prior Art

A head slider is attached on a gimbal of a flexure in a hard disk drive. The gimbal is received on a swelling of a head suspension at a position behind the head slider for a change of attitude around the swelling. The head suspension is attached to the front or tip end of a carriage arm of a carriage. The head slider is allowed to receive airflow generated along a rotating magnetic recording disk. The head slider is thus kept above the surface of the magnetic recording disk. An electromagnetic transducer mounted on the head slider executes the reading/wiring operation of magnetic bit data during the flight of the head slider.

In a load/unload mechanism, the front or tip end of the head suspension is received on a ramp member located at a position outside the magnetic recording disk. The carriage is driven to swing for the reading/writing operation of magnetic bit data. The tip end of the head suspension thus moves away from the ramp member. The head slider flies above the magnetic recording disk. The swinging movement of the carriage generates an inertial force acting on the flying head slider. The inertial force makes the head slider vibrate. The head slider sometimes unintentionally contacts with or collides against the magnetic recording disk. The magnetic recording disk can be damaged.

### SUMMARY OF THE INVENTION

It is accordingly an object of the present invention to provide a head suspension, a head suspension assembly and a storage apparatus, capable of suppressing the vibration of a head slider.

According to a first aspect of the present invention, there is provided a head suspension comprising: a plate-shaped load beam; a swelling formed on the load beam, the swelling being swollen on the surface of the load beam; a gimbal having the back surface received on the swelling of the load beam, the gimbal having the front surface defining a mounting area for receiving a head slider; and a viscoelastic body located between the load beam and the gimbal at a position adjacent to the swelling.

The head slider is mounted at the mounting area on the gimbal in the head suspension. The viscoelastic body is interposed between the load beam and the gimbal. The back surface of the gimbal is received on the swelling. The head slider on the gimbal is allowed to change its attitude on the swelling. When the gimbal is received on the viscoelastic body, the viscoelastic body serves to suppress the vibration of the gimbal, namely the head slider.

The viscoelastic body may be located at a position adjacent to the swelling in the lateral direction of the load beam. The viscoelastic body serves to significantly suppress the vibration of the head slider in the direction of a roll angle. The vibration is dominantly taken out from the head slider in the direction of a pitch angle. Since the vibration in the direction of the pitch angle dominates the vibration of the head slider, the vibration of the head slider resulting from contact between the head slider and a storage medium is detected with a high accuracy, for example. When a zero calibration is executed, for example, a contact can be detected between the head slider and the storage medium with a high accuracy.

A pair of viscoelastic bodies may be located between the load beam and the gimbal at both sides of the swelling. The pair of viscoelastic bodies may be integrally formed with each other.

According to a second aspect of the present invention, there is provided a head suspension assembly comprising: a head suspension; a swelling formed on the head suspension, the swelling being swollen on the surface of the head suspension; a gimbal having the back surface received on the swelling of the head suspension; a head slider mounted on the front surface of the gimbal, the head slider having the back received on the swelling; and a viscoelastic body located between the head suspension and the gimbal at a position adjacent to the swelling.

The head slider is mounted at the mounting area on the gimbal in the head suspension assembly. The viscoelastic body is interposed between the head suspension and the gimbal. The back surface of the gimbal is received on the swelling. The head slider on the gimbal is allowed to change its attitude on the swelling. When the gimbal is received on the viscoelastic body, the viscoelastic body serves to suppress the vibration of the gimbal, namely the head slider.

The viscoelastic body may be located at a position adjacent to the swelling in the lateral direction of the head suspension. A pair of viscoelastic bodies may be located between the head suspension and the gimbal at both sides of the swelling. The pair of viscoelastic bodies may be integrally formed with each other.

The head suspension and the head suspension assembly may be incorporated in a storage apparatus. The storage apparatus may comprise: a head slider opposed to a storage medium; a gimbal having the front surface receiving the head slider; a head suspension supporting the gimbal; a swelling formed on the head suspension, the swelling being swollen on the surface of the head suspension to receive the gimbal at a position behind the head slider; and a viscoelastic body located between the head suspension and the gimbal.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a plan view schematically illustrating the inner structure of a hard disk drive, HDD, as a specific example of a storage apparatus according to the present invention;

FIG. 2 is an enlarged perspective view schematically illustrating an example of a flying head slider incorporated in the storage apparatus;

FIG. 3 is a sectional view schematically illustrating an electromagnetic transducer mounted on the flying head slider;

FIG. 4 is a sectional view of a head protection film, schematically illustrating a “protrusion” formed on the flying head slider;

FIG. 5 is an enlarged perspective of a ramp member;

FIG. 6 is an enlarged perspective view schematically illustrating a head suspension assembly according to an embodiment of the present invention;

FIG. 7 is an enlarged partial exploded view schematically illustrating the head suspension assembly;

FIG. 8 is an enlarged partial sectional view schematically illustrating the head suspension assembly;

FIG. 9 is an enlarged partial side view schematically illustrating the head suspension assembly;

FIG. 10 is a block diagram schematically illustrating a control system of the hard disk drive related to the electromagnetic transducer and a heater mounted on the flying head slider;

FIG. 11 is a graph showing the output from a laser Doppler velocimeter;

FIG. 12 is a graph showing the output from a laser Doppler velocimeter;

FIG. 13 is a graph showing the output from a laser Doppler velocimeter;

FIG. 14 is a graph showing the output from a laser Doppler velocimeter;

FIG. 15 is an enlarged partial exploded view schematically illustrating a head suspension assembly according to another embodiment of the present invention;

FIG. 16 is an enlarged partial sectional view schematically illustrating the head suspension assembly;

FIG. 17 is an enlarged partial exploded view schematically illustrating a head suspension assembly according to another embodiment of the present invention; and

FIG. 18 is an enlarged partial sectional view schematically illustrating the head suspension assembly.

### DESCRIPTION OF THE PREFERRED EMBODIMENT

FIG. 1 schematically illustrates the inner structure of a hard disk drive, HDD, 11 as an example of a storage medium drive or a storage apparatus according to the present invention. The hard disk drive 11 includes an enclosure 12. The enclosure 12 includes a box-shaped base 13 and an enclosure cover, not shown. The base 13 defines an inner space in the form of a flat parallelepiped, for example. The base 13 may be made of a metallic material such as aluminum, for example. Molding process may be employed to form the base 13. The enclosure cover is coupled to the base 13 to close the opening of the base 13. An inner space is defined between the base 13 and the enclosure cover. Pressing process may be employed to form the enclosure cover out of a plate material, for example.

At least one magnetic recording disk 14 as a storage medium is enclosed in the enclosure 12. The magnetic recording disk or disks 14 are mounted on the driving shaft of a spindle motor 15. The spindle motor 15 drives the magnetic recording disk or disks 14 at a higher revolution speed such as 5,400 rpm, 7,200 rpm, 10,000 rpm, 15,000 rpm, or the like.

A carriage 16 is also enclosed in the enclosure 12. The carriage 16 includes a carriage block 17. The carriage block 17 is supported on a vertical support shaft 18 for relative rotation. Carriage arms 19 are defined in the carriage block 17. The carriage arms 19 are designed to extend in the horizontal direction from the vertical support shaft 18. The carriage block 17 may be made of aluminum, for example. Extrusion molding process may be employed to form the carriage block 17, for example.

A head suspension assembly 21 is attached to the front or tip end of the individual carriage arm 19. The head suspension assembly 21 includes a head suspension 22. The head suspension 22 extends forward from the tip end of the carriage arm 19. A flexure is attached to the head suspension 22. The flexure will be described later in detail. A so-called gimbal is defined in the flexure. A flying head slider 23 is mounted on the surface of the gimbal. The gimbal serves to realize a change of attitude of the flying head slider 23 relative to the head suspension 22. A magnetic head or electromagnetic transducer is mounted on the flying head slider 23 as described later in detail.

When the magnetic recording disk 14 rotates, the flying head slider 23 is allowed to receive airflow generated along the rotating magnetic recording disk 14. The airflow serves to generate a positive pressure or a lift as well as a negative pressure on the flying head slider 23. The flying head slider 23 is thus allowed to keep flying above the surface of the magnetic recording disk 14 during the rotation of the magnetic recording disk 14 at a higher stability established by the balance between the urging force of the head suspension 22 and the combination of the lift and the negative pressure.

A power source, namely a voice coil motor, VCM, 24 is coupled to the carriage block 17. The voice coil motor 24 serves to drive the carriage block 17 around the vertical support shaft 18. The rotation of the carriage block 17 allows the carriage arms 19 and the head suspensions 22 to swing. When the carriage arms 19 swing around the vertical support shaft 18 during the flight of the flying head slider 23, the flying head slider 23 is allowed to move along the radial direction of the magnetic recording disk 14. The electromagnetic transducer on the flying head slider 23 is in this manner positioned right above a target recording track on the magnetic recording disk 14.

As is apparent from FIG. 1, a flexible printed circuit board unit 25 is placed on the carriage block 17. The flexible printed circuit board unit 25 includes a head IC (integrated circuit) 27 mounted on a flexible printed wiring board 26. The head IC 27 is connected to the read head element and the write head element of the electromagnetic transducer. The flexure 28 is utilized to connect the head IC 27 to the electromagnetic transducer. The flexure 28 is connected to the flexible printed circuit board unit 25. The flexure 28 includes a wiring pattern. The flying head slider 23 is connected to the flexible printed wiring board 26 through the wiring pattern.

The head IC 27 is designed to supply the read head element of the electromagnetic transducer with a sensing current when the magnetic bit data is to be read. The head IC 27 is also designed to supply the write head element of the electromagnetic transducer with a writing current when the magnetic bit data is to be written. The value of the sensing current is set at a specific value. A small-sized circuit board 29 is located in the inner space of the enclosure 12. A printed circuit board, not shown, is attached to the back surface of the bottom plate of the base 13. The small-sized circuit board 29 and the printed circuit board are designed to supply the head IC 27 with the sensing current and the writing current.

A load tab 31 is defined in the front or tip end of the individual head suspension 22. The load tab 31 extends further forward from the tip end of the head suspension 22. The swinging movement of the carriage arm 19 allows the load tab 31 to move along the radial direction of the magnetic recording disk 14. A ramp member 32 is located on the movement path of the load tab 31 in a space outside the magnetic recording disk 14. The load tab 31 is received on the ramp member 32. The ramp member 32 and the load tabs 31 in combination establish a so-called load/unload mechanism. The ramp member 32 will be described later in detail.

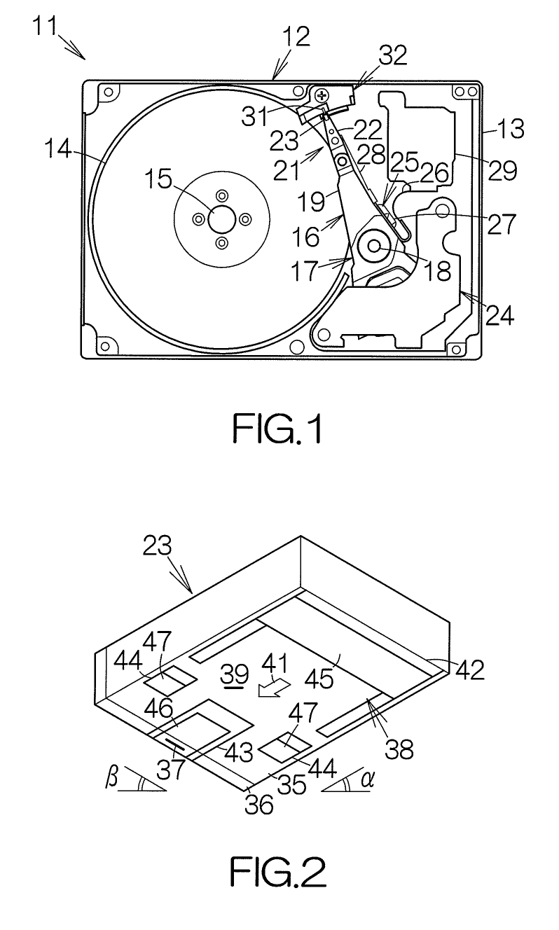

FIG. 2 illustrates a specific example of the flying head slider 23. The flying head slider 23 includes a slider body 35 in the form of a flat parallelepiped, for example. The slider body 35 may be made of Al₂O₃—TiC. A head protection film 36 is overlaid on the outflow or trailing end of the slider body 35. The aforementioned magnetic head or electromagnetic transducer 37 is embedded in the head protection film 36. A medium-opposed surface or bottom surface 38 is defined over the slider body 35 so as to face the magnetic recording disk 14 at a distance. A flat base surface 39 as a reference surface is defined on the bottom surface 38. When the magnetic recording disk 14 rotates, airflow 41 flows along the bottom surface 38 from the front or leading end of the slider body 35 toward the rear or trailing end of the slider body 35.

A front rail 42 is formed on the bottom surface 38. The front rail 42 stands upright from the base surface 39 at a position near the inflow end of the base surface 39. A rear rail 43 is likewise formed on the bottom surface 38. The rear rail 43 stands upright from the base surface 39 at a position near the outflow end of the base surface 39. A pair of rear side rails 44, 44 is further formed on the bottom surface 38. The rear side rails 44, 44 stand upright from the base surface 39 at positions near the outflow end of the base surface 39. Air bearing surfaces, ABSs, 45, 46, 47 are respectively defined on the top surfaces of the front rail 42, the rear rail 43 and the rear side rails 44. Steps are formed to connect the inflow ends of the air bearing surfaces 45, 46, 47 to the top surfaces of the rails 42, 43, 44, respectively.

The bottom surface 38 receives the airflow 41 generated along the rotating magnetic recording disk 14. The steps serve to generate a relatively large positive pressure or lift at the air bearing surfaces 45, 46, 47. Moreover, a relatively large negative pressure is generated behind the front rail 42. The flying head slider 23 is thus allowed to take a flying attitude based on the balance between the lift and the negative pressure.

The airflow 41 is generated along the surface of the rotating magnetic recording disk 14 as described above. A larger positive pressure or lift is generated at the air bearing surface 45 as compared with the air bearing surfaces 46, 47 in the flying head slider 23. When the flying head slider 23 flies above the surface of the magnetic recording disk 14, the flying head slider 23 is kept at an inclined attitude defined by a pitch angle α. The term “pitch angle” is used to define an inclined angle in the longitudinal direction of the slider body 35 along the direction of the airflow 41.

When the carriage arm 19 is driven to swing during the rotation of the magnetic recording disk 14, the flying head slider 23 is allowed to move along the radial direction of the magnetic recording disk 14, for example. The flying head slider 23 suffers from a so-called yaw angle. The side surface of the slider body 35 receives airflow based on the yaw angle. The slider body 35 is thus forced to take an inclined attitude defined by a roll angle β. The term “roll angle” is used to define an inclined angle in the lateral direction of the slider body 35 perpendicular to the direction of the airflow 41.

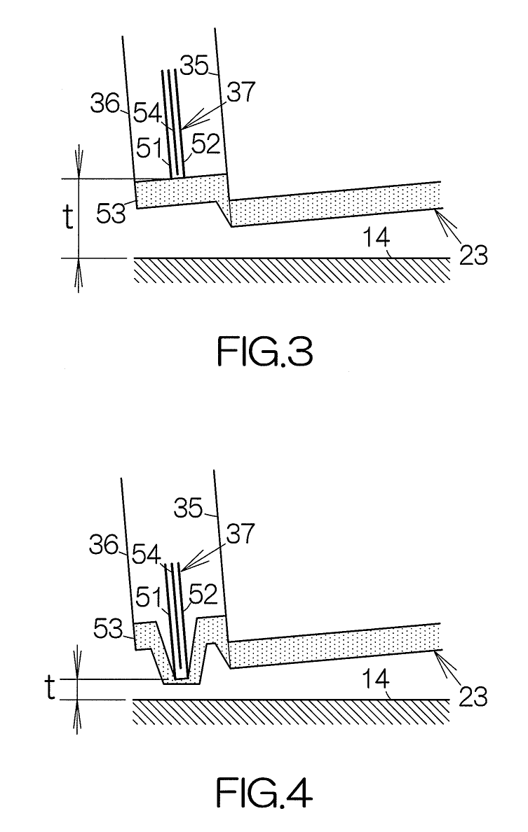

As shown in FIG. 3, the electromagnetic transducer 37 includes a write head element 51 and a read head element 52. The write head element 51 includes a so-called thin film magnetic head designed to write magnetic bit data into the magnetic recording disk 14 by utilizing a magnetic field induced at a thin film coil pattern. The read head element 52 includes a giant magnetoresistive (GMR) element or a tunnel-junction magnetoresistive (TMR) element designed to discriminate magnetic bit data on the magnetic recording disk 14 by utilizing variation in the electric resistance of a spin valve film or a tunnel-junction film, for example. A protection film 53 is formed on the surface of the rear rail 43. The protection film 53 covers over the write gap of the write head element 51 and the read gap of the read head element 52. The protection film 53 may be made of a diamond-like-carbon (DLC), for example.

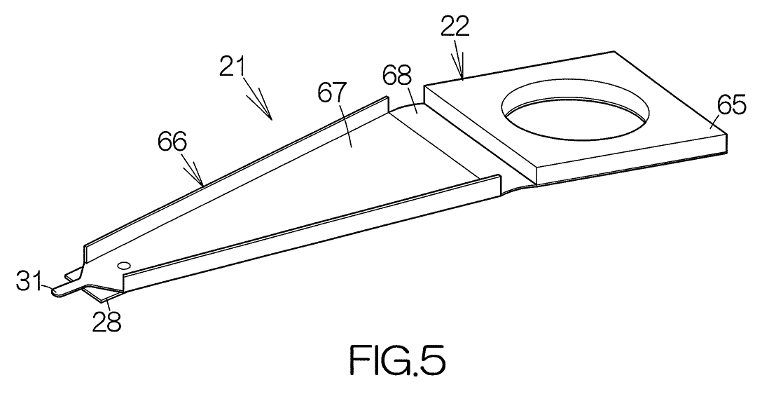

A heater 54 is incorporated in the head protection film 36. The heater 54 is related to the electromagnetic transducer 37. The heater 54 includes a heating wiring pattern. The heater 54 may extend along an imaginary plane perpendicular to the air bearing surface 46, for example. The thin film coil pattern of the write head element 51 and the head protection film 36 expand in response to heat generated by the heater 54 when electric power is supplied to the heater 54. The front end of the electromagnetic transducer 37 protrudes from the surface of the head protection film 36, as shown in FIG. 4. This results in establishment of a so-called protrusion. The write head element 51 and the read head element 52 thus get closer to the magnetic recording disk 14. The protrusion amount serves to determine the flying height t of the electromagnetic transducer 37.

As shown in FIG. 5, the ramp member 32 includes a ramp body 55 molded from a hard plastic material, for example. The ramp body 55 includes an attachment base 56 fixed to the bottom plate of the base 13 at a position outside the magnetic recording disk 14. The attachment base 56 may be screwed on the base 13, for example. Ramp pieces 57 are formed in the attachment base 56. The ramp pieces 57 protrude toward the vertical support shaft 18 of the carriage 16 along horizontal planes. The ramps 57 are formed integral to the attachment base 56 based on molding process, for example. A receiving indent 58 is formed in the attachment base 56 and the individual ramp piece 57. The magnetic recording disk 14 is received in the receiving indent 58.

Guiding passages 59, 59 are formed on the upward and downward surfaces of the individual ramp piece 57, respectively. The guiding passages 59 extend along an arc of a predetermined curvature having the center at the longitudinal axis of the vertical support shaft. When the carriage 16 is driven to swing around the vertical support shaft 18, the individual load tab 31 is allowed to slide on the guiding passage 59 from the inner end to the outer end of the guiding passage 59. The guiding passage 59 serves as a movement path of the load tab 31. The guiding passage 59 includes a first guiding passage 61 extending outward from the inner end of the guiding passage 59 in the radial direction of the magnetic recording disk 14. The first guiding passage 61 gets farther from the surface of the magnetic recording disk 14 as the position moves outward in the radial direction of the magnetic recording disk 14. A second guiding passage 62 is formed at a position outside the first guiding passage 61. The second guiding passage 62 extends toward a depression 63. The second guiding passage 62 is connected to the highest end or the outer end of the first guiding passage 61.

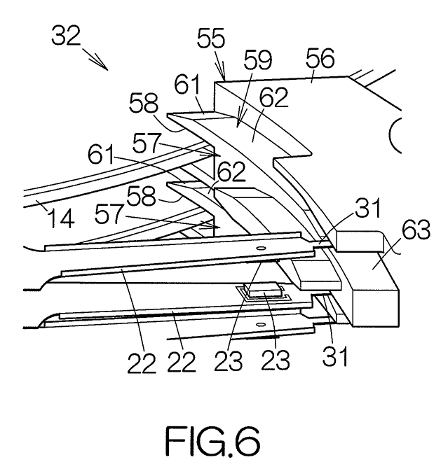

FIG. 6 schematically illustrates the head suspension assembly 21 according to an embodiment of the present invention. The head suspension 22 includes an attachment plate 65 and a plate-shaped load beam 66 extending forward from the attachment plate 65. Caulking may be employed to fix the attachment plate 65 to the carriage arm 19, for example. The load beam 66 defines a rigid portion 67 and an elastic bending section 68. The rigid portion 67 is spaced from the attachment plate 65 at a predetermined interval. The elastic bending section is defined between the rigid portion 67 and the attachment plate 65. A support body, namely the flexure 28 is attached to the front end of the load beam 66. The elastic bending section 68 of the load beam 66 is designed to exhibit elasticity or bending force of a predetermined intensity. The bending force serves to provide the aforementioned urging force of the head suspension 22 to the front end of the rigid portion 67.

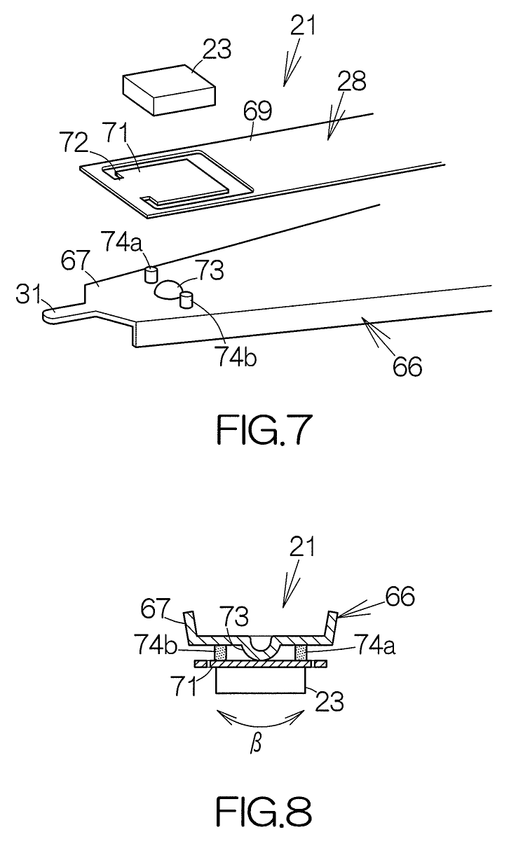

As shown in FIG. 7, the flexure 28 includes a fixation plate 69 and a gimbal 71. The fixation plate 69 is fixed on the surface of the rigid portion 67. The gimbal 71 serves as a support plate for receiving the flying head slider 23 at a predetermined mounting area define on the surface of the gimbal 71. The flying head slider 23 is bonded to the surface of the gimbal 71. A gimbal spring 72 connects the gimbal 71 to the fixation plate 69. The gimbal spring 72 extends forward from the front end of the gimbal 71. The gimbal spring 72 accepts a change in the attitude of the gimbal 71, namely of the flying head slider 23. The fixation plate 69, the gimbal 71 and the gimbal spring 72 are made out of a single leaf spring material. The leaf spring material may be a stainless steel plate having a constant thickness, for example. A domed swelling 73 is formed on the surface of the rigid portion 67 of the load beam 66. When the fixation plate 69 of the flexure 28 is attached to the surface of the load beam 66, the gimbal 71 is received on the domed swelling 73 at a position behind the flying head slider 23.

A pair of viscoelastic bodies 74a, 74b are fixed on the surface of the rigid portion 67 at positions adjacent to the domed swelling 73. The viscoelastic bodies 74a, 74b are arranged on an imaginary line perpendicular to the longitudinal centerline of the load beam 66. The viscoelastic bodies 74a, 74b are thus arranged at both sides of the domed swelling 73 in the lateral direction of the load beam 66. When the flying head slider 23 is positioned above the magnetic recording disk 14, the viscoelastic bodies 74a, 74b are positioned along the radial direction of the magnetic recording disk 14. The domed swelling 73 is located between the viscoelastic bodies 74a, 74b. The viscoelastic bodies 74a, 74b are formed in a columnar shape, for example.

The viscoelastic bodies 74a, 74b are made of a damping material, PIEZON® produced by KISO INDUSTRY CO, LTD., for example. The viscoelastic bodies 74a, 74b exhibit relatively low damping characteristics at a frequency of one [kHz] to several decades [kHz] approximately. The viscoelastic bodies 74a, 74b exhibit relatively high damping characteristics at a frequency of 100 [kHz] to several hundreds [kHz] approximately. It should be noted that the viscoelastic bodies 74a, 74b may be made of a different damping material as long as the damping material is suitable for the uses of the present invention. Such a damping material may preferably be a viscoelastic body having damping characteristics, such as a high polymer material, a low polymer material, an organic material, an inorganic material, and the like, for example. The damping material in a fluid state may be dropped on the surface of the rigid portion 67 to form the viscoelastic bodies 74a, 74b. In this case, the damping material may be dissolved or dispersed in a solvent. Alternatively, inkjet process may be employed to spray the damping material on the surface of the rigid portion 67, for example. Otherwise, the viscoelastic bodies 74a, 74b may be made of a damping material having photosensitivity. In this case, photolithography may be employed to form the viscoelastic bodies 74a, 74b, for example.

As shown in FIG. 8, the viscoelastic bodies 74a, 74b are located between the gimbal 71 and the rigid portion 67. The viscoelastic bodies 74a, 74b and the domed swelling 73 have the same height from the surface of the load beam 66. The gimbal 71 is received on the viscoelastic bodies 74a, 74b at both the sides of the domed swelling 73. The viscoelastic bodies 74a, 74b are arranged adjacent to the domed swelling 73 in the lateral direction of the load beam 66 as described above, so that the viscoelastic bodies 74a, 74b are designed to receive the gimbal 71, namely the flying head slider 23, suffering from a change in the pitch angle α of the flying head slider 23. As shown in FIG. 9, the gimbal 71, namely the flying head slider 23, is allowed to enjoy a change in its attitude, namely a change in the pitch angle α around the domed swelling 73 and the viscoelastic bodies 74a, 74b.

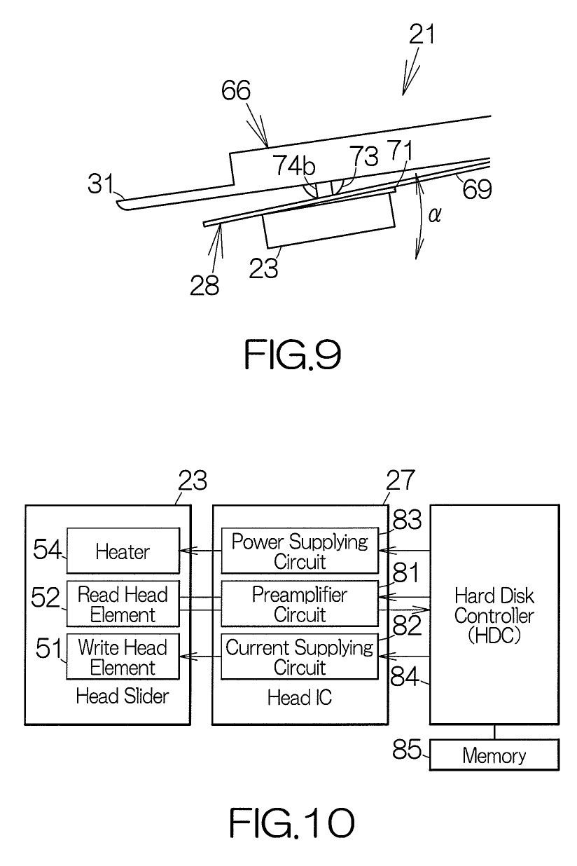

As shown in FIG. 10, a preamplifier circuit 81, a current supplying circuit 82 and a power supplying circuit 83 are incorporated in the head IC 27. The preamplifier circuit 81 is connected to the read head element 52. A sensing current is supplied to the read head element 52 from the preamplifier circuit 81. The current value of the sensing current is kept constant. The current supplying circuit 82 is connected to the write head element 51. A writing current is supplied to the write head element 51 from the current supplying circuit 82. A magnetic field is generated in the write head element 51 based on the supplied writing current. The power supplying circuit 83 is connected to the heater 54. The power supplying circuit 83 is designed to supply predetermined electric power to the heater 54. The heater 54 gets heated in response to the supply of the electric power. The temperature of the heater 54 is determined depending on electric energy. Specifically, the protrusion amount of the protrusion is controlled based on the electric energy.

A hard disk controller (HDC), namely a controller circuit 84 is connected to the head IC 27. The controller circuit 84 is designed to control the head IC 27 for the supply of the sensing current, the writing current and the electric power. The controller circuit 84 is also designed to detect the voltage of the sensing current. The preamplifier circuit 81 amplifies the voltage of the sensing current prior to the detection. The controller circuit 84 discriminates binary data based on the output from the preamplifier circuit 81. The controller circuit 84 also detects “jiggle” or “vibration” of the voltage based on the output from the preamplifier circuit 81. When the aforementioned protrusion contacts with the magnetic recording disk 14, for example, the flying head slider 23 is subjected to as light vibration. This results in generation of the “jiggle” in the voltage of the sensing current. The controller circuit 84 is designed to detect the “jiggle”.

The controller circuit 84 is designed to control the operations of the preamplifier circuit 81, the current supplying circuit 82 and the power supplying circuit 83 in accordance with a predetermined software program. The software program may be stored in a memory 85, for example. The software program is utilized to conduct zero calibration. The zero calibration will be described later in detail. Necessary data may also be stored in the memory 85. The software program and the data may be supplied to the memory 85 from other storage medium/media. The controller circuit 84 and the memory 85 may be mounted on the small-sized circuit board 29, for example.

The protrusion amount of the electromagnetic transducer 37 is determined prior to the reading/writing operation of magnetic bit data in the hard disk drive 11. A so-called zero calibration is executed to determine the protrusion amount. The protrusion amount of the protrusion is measured in the zero calibration at the moment of the contact of the protrusion with the magnetic recording disk 14. The protrusion amount of the protrusion for the reading/writing operation, in other words, for the normal flight of the flying head slider 23, is determined based on the measured protrusion amount. When the protrusion amount of the protrusion for the reading/writing operation is determined, the electromagnetic transducer 37, namely the write head element 51, is allowed to fly above the surface of the magnetic recording disk 14 at a predetermined flying height t. The zero calibration may be executed at every startup or boot of the hard disk drive 11, for example.

The controller circuit 84 executes the predetermined software program for the zero calibration. When the software program is executed, the controller circuit 84 is first designed to set an initial condition of the hard disk drive 11. The magnetic recording disk 14 is driven to rotate at a predetermined speed. Simultaneously, the voice coil motor 24 is driven so that the carriage 16 swings around the vertical support shaft 18. The flying head slider 23 is thus opposed to the surface of the magnetic recording disk 14. The flying head slider 23 flies above the magnetic recording disk 14 at a predetermined flying height. In addition, the controller circuit 84 supplies electric current to the head IC 27. The controller circuit 84 monitors the output from the preamplifier circuit 81. Specifically, the controller circuit 84 observes the voltage level of the sensing current. The power supplying circuit 83 suspends the supply of electric power at this moment.

When the initial condition has been established, the controller circuit 84 supplies an instruction signal to the power supplying circuit 83 to increase the protrusion amount of the protrusion by a predetermined increment. The power supplying circuit 83 supplies the heater 54 with electric power in response to the reception of the instruction signal. When the protrusion amount of the protrusion is increased, the controller circuit 84 judges the “contact”. The controller circuit 84 observes whether or not the aforementioned “jiggle” appears in the voltage of the sensing current. In the case where “jiggle” cannot be observed, the controller circuit 84 again supplies an instruction signal to the power supplying circuit 83 to increase the protrusion amount of the protrusion by the predetermined increment. The controller circuit 84 again and again output instruction signals to increase the protrusion amount of the protrusion until the “jiggle” is observed. When the “jiggle” has been observed, the controller circuit 84 determines that the protrusion contacts with the magnetic recording disk 14. The controller circuit 84 specifies the protrusion amount of the protrusion at this moment. The protrusion amount of the protrusion is in this manner determined at the moment of the contact the protrusion with the magnetic recording disk 14. The determined protrusion amount is stored in the memory 85, for example. This is the completion of the zero calibration.

The vibration of the flying head slider 23 has a component in the direction of the pitch angle α and a component in the direction of the roll angle β. The vibration of the pitch angle α is specified around the axis which passes through the contact point between the gimbal 71 and the domed swelling 73 in the lateral direction of the load beam 66. The vibration of the roll angle β is specified around the axis which passes through the contact point between the gimbal 71 and the domed swelling 73 in the longitudinal direction of the load beam 66. When the flying head slider 23 is forced to vibrate due to the contact between the protrusion of the flying head slider 23 and the magnetic recording disk 14, the flying head slider 23 suffers from a vibration having frequency in a range between 100 [kHz] and several hundreds [kHz] approximately, for example. The viscoelastic bodies 74a, 74b are located adjacent to the domed swelling 73 in the lateral direction of the load beam 66 as described above. The viscoelastic bodies 74a, 74b exhibit relatively high damping characteristics in a frequency ranging from 100 [kHz] to several hundreds [kHz] approximately. The vibration in the direction of the roll angle β is thus significantly suppressed in the flying head slider 23 as compared with the vibration in the direction of the pitch angle α. The vibration can be detected in the direction of the pitch angle α with a high accuracy. Since the vibration in the direction of the pitch angle α dominates the overall vibration of the flying head slider 23, the aforementioned “jiggle” can be observed with a high accuracy. Contact can be detected between the protrusion of the flying head slider 23 and the magnetic recording disk 14 with a high accuracy.

Now, assume that magnetic bit data is to be read out of a magnetic pattern on the magnetic recording disk 14. The spindle motor 15 is driven to rotate at a constant speed, so that the magnetic recording disk or disks 14 rotates. The flying head slider 23 is opposed to the rotating magnetic recording disk 14. An air bearing is formed between the flying head slider 23 and the surface of the magnetic recording disk 14. The flying head slider 23 is kept flying during the rotation of the magnetic recording disk 14.

The vibration of the flying head slider 23 has a frequency ranging from one [kHz] to several decades [kHz] approximately, for example, during the flight of the flying head slider 23. The viscoelastic bodies 74a, 74b have relatively low damping characteristics in a frequency ranging from one [kHz] to several decades [kHz] approximately, as described above. The vibrations in the directions of the pitch angle α and the roll angle β are suppressed during the flight of the flying head slider 23 to a certain extent. However, the vibration in the direction of the roll angle β is not suppressed as much as when the flying head slider 23 contacts with the magnetic recording disk 14. The flying head slider 23 is thus allowed to change its attitude for the reading operation of magnetic bit data irrespective of the existence of the viscoelastic bodies 74a, 74b.

When magnetic bit data is read out, the flying head slider 23 is intended to move outward to a position outside the magnetic recording disk 14. Electric current of a predetermined value is supplied to the voice coil motor 24. The carriage 16 is driven to swing around the vertical support shaft 18 in the normal direction. The tip end of the individual head suspension 22 thus moves toward the outer periphery of the magnetic recording disk 14. The load tab 31 moves outward in the radial direction of the magnetic recording disk 14.

The swinging movement of the carriage 16 allows the load tab 31 to contact with the guiding passage 59 of the ramp member 32. The load tab 31 slides upward along the first guiding passage 61. The flying head slider 23 is lifted up in a space on the surface of the magnetic recording disk 14 during the sliding movement of the load tab 31 along the first guiding passage 61. The lift and the negative pressure of the flying head slider 23 in this manner disappear. The flying head slider 23 is supported on the ramp member 32 with the assistance of the load tab 31. The rotation of the magnetic recording disk 14 may be stopped at this moment. The further swinging movement of the carriage 16 allows the load tab 31 to slide from the second guiding passage 62 on the ramp member 32 to the depression 63. The supply of the electric current to the voice coil motor 24 is stopped. The swinging movement of the carriage 16 is thus stopped. The load tab 31 is held in the depression 63.

At the beginning of the reading operation, the rotation of the magnetic recording disk 14 first starts. When the rotation of the magnetic recording disk 14 enters a steady condition, an electric current of a predetermined value is supplied to the voice coil motor 24. The carriage 16 is driven to swing in the reverse direction. The load tab 31 slides from the depression 63 to the second guiding passage 62. The load tab 31 slides from the second guiding passage 62 to the first guiding passage 61. The load tab 31 slides downward along the first guiding passage 61. The flying head slider 23 gradually gets closer to the surface of the magnetic recording disk 14. When the flying head slider 23 receives a sufficient amount of airflow from the magnetic recording disk 14, the lift is generated on the flying head slider 23. An air bearing is formed between the flying head slider 23 and the surface of the magnetic recording disk 14. When the load tab 31 moves away from the first guiding passage 61, the air bearing allows the flying head slider 23 to keep flying.

In particular, when the load tab 31 is released from a support of the first guiding passage 61, namely the ramp member 32, an inertial force acts on the flying head slider 23. The inertial force makes the flying head slider 23 vibrate. The induced vibration has a frequency of 100 [kHz] or larger, for example. The gimbal 71 is received on the viscoelastic bodies 74a, 74b. The viscoelastic bodies 74a, 74b exhibit relatively high damping characteristics in a frequency ranging from 100 [kHz] to several hundreds [kHz] approximately. When the flying head slider 23 is loaded, the vibration of the flying head slider 23 is significantly suppressed in the direction of the roll angle β. Contact is prevented between the flying head slider 23 and the magnetic recording disk 14. The surface of the magnetic recording disk 14 is thus prevented from being damaged.

When the flying head slider 23 is loaded, the viscoelastic bodies 74a, 74b serve to significantly suppress the vibration of the flying head slider 23 in the direction of the roll angle β in the hard disk drive 11. Contact is prevented between the flying head slider 23 and the magnetic recording disk 14. On the other hand, the flying head slider 23 is allowed to change its attitude in the directions of the pitch angle α and the roll angle β for the reading/writing operation of magnetic bit data irrespective of the existence of the viscoelastic bodies 74a, 74b. The reading/writing operation of magnetic bit data can be executed as usual. In addition, when the zero calibration is executed, the viscoelastic bodies 74a, 74b serve to significantly suppress the vibration of the flying head slider 23 in the direction of the roll angle β. It is thus possible to detect a contact between the protrusion of the flying head slider 23 and the magnetic recording disk 14 with a high accuracy.

The present invention is also applicable to a test for the hard disk drive 11 before shipment from a factory. The flying head slider 23 is opposed to the rotating magnetic recording disk 14 in the same manner as the case where magnetic bit data is to be read/written. The controller circuit 84 observes whether or not “jiggle” appears in the voltage level. A protrusion of a predetermined protrusion amount is formed in the flying head slider 23 at this moment. When “jiggle” is observed, the controller circuit 84 determines that the protrusion contacts with a protrusion formed on the surface of the magnetic recording disk 14. The controller circuit 84 in this manner specifies a contact area on the surface of the magnetic recording disk 14 before the shipment. Writing of magnetic bit data may be refrained on such a contact area on the surface of the magnetic recording disk 14 in the practical use of the hard disk drive 11.

The present inventor has observed the effect of the present invention. A hard disk drive with an enclosure cover removed was prepared for the observation. A hard disk drive according to a specific example was the hard disk drive 11 according to the present invention. A hard disk drive according to a comparative example was a conventional hard disk drive without the viscoelastic bodies 74a, 74b. The vibration of the flying head slider was measured during the flight of the flying head slider above the rotating magnetic recording disk. The vibration was measured not only during the normal flight of the flying head slider but also when the flying head slider contacts with the magnetic recording disk. A laser Doppler velocimeter (LDV) was utilized to measure the vibration. The vibration was measured based on the comparison between the light irradiated to the flying head slider and the light reflected from the flying head slider.

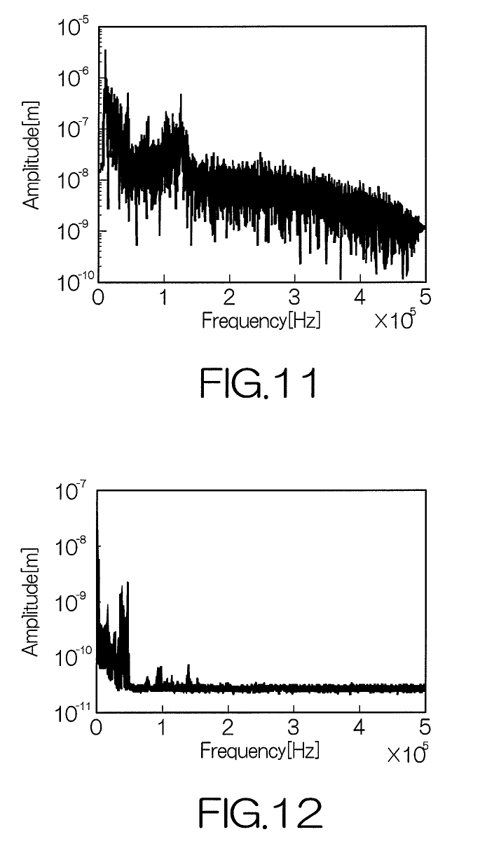

FIG. 11 illustrates the result of detection of the vibration during the normal flight of the flying head slider in the hard disk drive according to the comparative example. As shown in FIG. 11, vibrations of relatively large amplitudes were detected all over the frequency range in the hard disk drive according to the comparative example. FIG. 12 illustrates the result of detection of the vibration during the normal flight of the flying head slider in the hard disk drive according to a specific embodiment. As shown in FIG. 12, the amplitude of the vibration was reduced in all the frequency ranges in the hard disk drive according to the specific embodiment. The effect of the present invention on suppression of the vibration has been confirmed. It should be noted that the vibration of a predetermined amplitude was detected in a predetermined frequency range up to several decades [kHz]. It has been confirmed that the viscoelastic bodies 74a, 74b achieve suppression of the vibration of the flying head slider during the normal flight of the flying head slider.

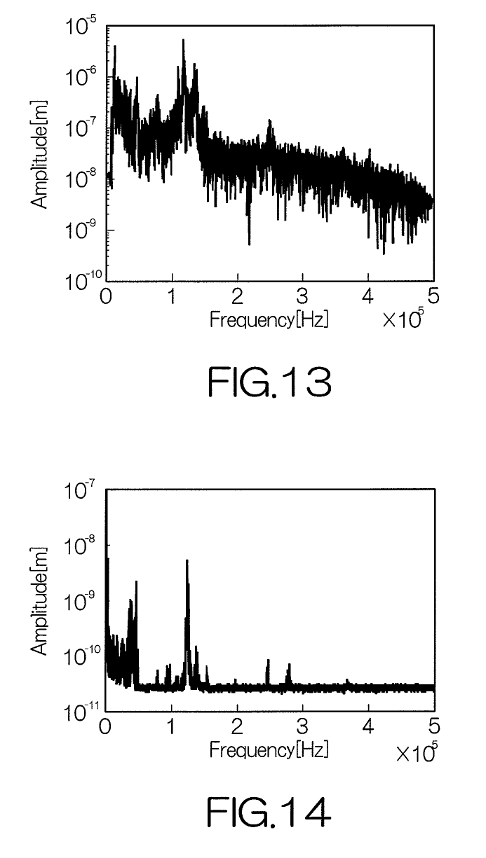

FIG. 13 illustrates the result of detection of the vibration of the flying head slider at the moment when the flying head slider contacts with the magnetic recording disk in the hard disk drive according to the comparative example. As shown in FIG. 13, vibrations of relatively large amplitudes were likewise detected all over the frequency range in the hard disk drive according to the comparative example. FIG. 14 illustrates the result of detection of the vibration of the flying head slider at the moment when the flying head slider contacts with the magnetic recording disk in the hard disk drive according to the specific embodiment. As shown in FIG. 14, the amplitudes of the vibrations were reduced in all the frequency ranges in the hard disk drive according to the specific embodiment. The effect of the present invention on suppression of the vibration has been confirmed. It should be noted that the vibration of a predetermined amplitude was detected only in predetermined frequency ranges. It has been confirmed that the viscoelastic bodies 74a, 74b achieve a considerable suppression of the vibration of the flying head slider when the flying head slider contacts with the magnetic recording disk.

Moreover, the comparison between the result of FIG. 12 and that of FIG. 14 reveals that the vibrations of relatively large amplitudes were detected at the moment when the flying head slider 23 contacts with the magnetic recording disk in the frequency ranging from 100 [kHz] to 150 [kHz] approximately as compared with during the normal flight of the flying head slider. Specifically, an obvious change of attitude was observed in the specific frequency ranges in response to a contact. The amplitudes are relatively small in the frequency ranges other than the specific frequency ranges in the hard disk drive according to the specific embodiment. It is thus possible to reliably detect a contact between the flying head slider and the magnetic recording disk with a high accuracy based on observation of the specific frequency ranges. According to the comparison between the result of FIG. 11 and that of FIG. 13, it has been confirmed that the vibrations of relatively large amplitudes were detected in all the frequency ranges. It is thus difficult to specify a change in the amplitude for detection of a contact between the flying head slider 23 and the magnetic recording disk 14.

The hard disk drive 11 may utilize an acoustic emission (AE) sensor for detection of the vibration of the flying head slider 23. The acoustic emission sensor may be attached to the carriage block 17. The acoustic emission sensor detects the vibration only in the direction of the pitch angle α in the same manner as described above. The acoustic emission sensor or the laser Doppler velocimeter (LDV) can also be utilized to detect the vibration of the flying head slider 23 for the aforementioned test for the hard disk drive 11 before the shipment.

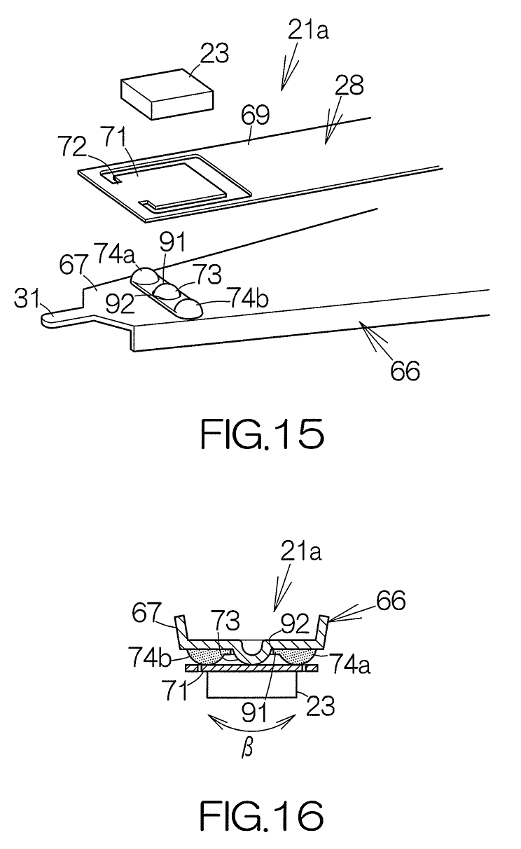

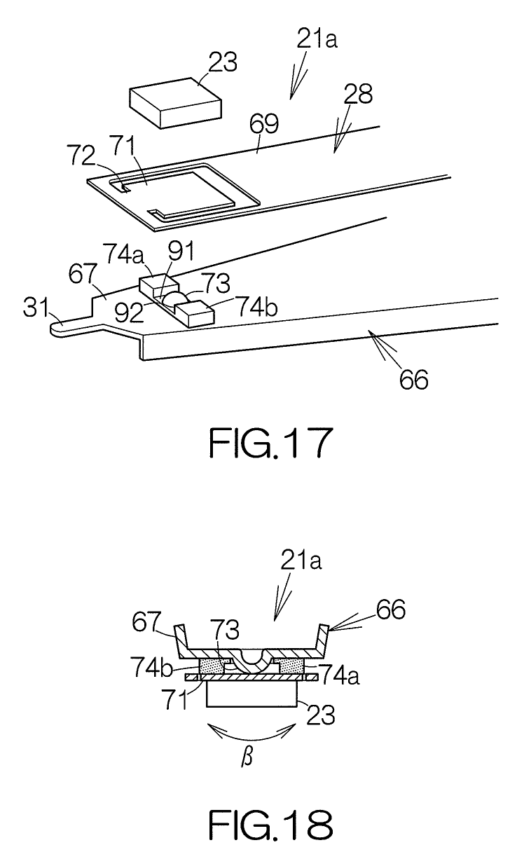

FIG. 15 schematically illustrates a head suspension assembly 21a according to a modification of the present embodiment. The viscoelastic bodies 74a, 74b are formed in the shape of a dome in the head suspension assembly 21a, for example. A connecting piece 91 serves to unify the viscoelastic bodies 74a, 74b. The connecting piece 91 extends in the lateral direction of the load beam 66. The connecting piece 91 is formed in the shape of a plate extending along the surface of the rigid portion 67. Referring also to FIG. 16, the domed swelling 73 is received in a through hole 92 formed in the connecting piece 91. Like reference numerals are attached to the structure or components equivalent to those of the aforementioned head suspension assembly 21.

Alternatively, the viscoelastic bodies 74a, 74b may be formed in the shape of a prism in the aforementioned head suspension assembly 21a, for example. The viscoelastic bodies 74a, 74b and the connecting piece 91 may be integrally molded from the aforementioned damping material as a one-piece component. The one-piece component may be bonded to the surface of the rigid portion 67 by using an adhesive, for example. The head suspension assembly 21a is allowed to enjoy the advantages identical to those obtained in the aforementioned one.

What is claimed is:

1. A head suspension comprising:
a plate-shaped load beam;
a swelling formed on the load beam, the swelling being swollen on a surface of the load beam;
a gimbal having a back surface received on the swelling of the load beam, the gimbal having a front surface defining a mounting area for receiving a head slider; and
a viscoelastic body located between the load beam and the gimbal at a position adjacent to the swelling.

2. The head suspension according to claim 1, wherein the viscoelastic body is located at a position adjacent to the swelling in a lateral direction of the load beam.

3. The head suspension according to claim 2, wherein a pair of viscoelastic bodies is located between the load beam and the gimbal at both sides of the swelling.

4. The head suspension according to claim 3, wherein the pair of viscoelastic bodies is integrally formed with each other.

5. A head suspension assembly comprising:
a head suspension;
a swelling formed on the head suspension, the swelling being swollen on a surface of the head suspension;
a gimbal having a back surface received on the swelling of the head suspension;
a head slider mounted on a front surface of the gimbal, the head slider having a back received on the swelling; and
a viscoelastic body located between the head suspension and the gimbal at a position adjacent to the swelling.

6. The head suspension assembly according to claim 5, wherein the viscoelastic body is located at a position adjacent to the swelling in a lateral direction of the head suspension.

7. The head suspension assembly according to claim 6, wherein a pair of viscoelastic bodies is located between the head suspension and the gimbal at both sides of the swelling.

8. The head suspension assembly according to claim 7, wherein the pair of viscoelastic bodies is integrally formed with each other.

9. A storage apparatus comprising:
a head slider opposed to a storage medium;
a gimbal having a front surface receiving the head slider;
a head suspension supporting the gimbal;
a swelling formed on the head suspension, the swelling being swollen on a surface of the head suspension to receive the gimbal at a position behind the head slider; and
a viscoelastic body located between the head suspension and the gimbal.

10. The storage apparatus according to claim 9, wherein the viscoelastic body is located at a position adjacent to the swelling in a lateral direction of the head suspension.

11. The storage apparatus according to claim 10, wherein a pair of viscoelastic bodies is located between the head suspension and the gimbal at both sides of the swelling.

12. The storage apparatus according to claim 11, wherein the pair of viscoelastic bodies is integrally formed with each other.
